(19) United States
(12) Patent Application Publication
(10) Pub. No.: US 2013/0342865 A1
(43) Pub. Date: Dec. 26, 2013

(54) DEVICE DISCOVERY THROUGH A MACHINE READABLE USER INTERFACE

(71) Applicant: Toshiba Tec Kabushiki Kaisha, Tokyo (JP)

(72) Inventors: Sarah Shekher, Santa Barbara, CA (US); Michael Yeung, Mission Viejo, CA (US)

(21) Appl. No.: 13/922,883

(22) Filed: Jun. 20, 2013

Related U.S. Application Data
(60) Provisional application No. 61/662,855, filed on Jun. 21, 2012.

(51) Int. Cl. G06K 15/00

(52) U.S. Cl. CPC G06K 15/4045
USPC 358/1.14

(57) ABSTRACT

Systems and methods for device discovery through a machine readable interface are disclosed. The method includes obtaining a uniquely identifying network address for the multifunction peripheral, generating a machine-readable symbol embodying the uniquely identifying network address and associated authentication credentials, and displaying a machine-readable symbol on a display associated with the user interface of the multifunction peripheral. The method further includes accepting a document processing request sent via a network to the uniquely identifying network address associated with the machine-readable symbol, the document processing request including the authentication credentials and beginning the document processing request using the multifunction peripheral.

### RELATED APPLICATION INFORMATION

This patent claims priority from U.S. Patent Application No. 61/662,855 entitled “System and Method to Perform Intelligent Device Discovery Through Dynamic QR Code Recognition” filed Jun. 21, 2012.

### BACKGROUND

1. Field

This disclosure relates to user interfaces and to device discovery.

2. Description of the Related Art

A multifunction peripheral (MFP) is a type of document processing device which is an integrated device providing at least two document processing functions, such as print, copy, scan and fax. In a document processing function, an input document (electronic or physical) is used to automatically produce a new output document (electronic or physical).

Documents may be physically or logically divided into pages. A physical document is paper or other physical media bearing information which is readable unaided by the typical human eye. An electronic document is any electronic media content (other than a computer program or a system file) that is intended to be used in either an electronic form or as printed output. Electronic documents may consist of a single data file, or an associated collection of data files which together are a unitary whole. Electronic documents will be referred to further herein as documents, unless the context requires some discussion of physical documents which will be referred to by that name specifically.

In printing, the MFP automatically produces a physical document from an electronic document. In copying, the MFP automatically produces a physical document from a physical document. In scanning, the MFP automatically produces an electronic document from a physical document. In faxing, the MFP automatically transmits via fax an electronic document from an input physical document which the MFP has also scanned or from an input electronic document which the MFP has converted to a fax format.

MFPs are often incorporated into corporate or other organization's networks which also include various other workstations, servers and peripherals. An MFP may also provide remote document processing services to external or network devices.

MFP discovery is required before any device may utilize an MFP. Discovery typically involves the manual or automated inputting of a network name or an internet protocol (IP) address for the MFP into a suitable device driver or similar application on a device. At that point, the device can configure and, if appropriately configured, utilize the functionality provided by the MFP.

### DESCRIPTION OF THE DRAWINGS

FIG. 1 is a diagram of an MFP system.

FIG. 2 is a block diagram of an MFP.

FIG. 3 is a block diagram of a computing device.

FIG. 4 is a block diagram of a software system for an MFP.

FIG. 5 is a multifunction peripheral user interface.

FIG. 6 is a multifunction peripheral user interface and a mobile device including a camera and a mobile device user interface.

FIG. 7 is a mobile device including a mobile device user interface.

FIG. 8 is a flowchart for the operation of the multifunction peripheral.

FIG. 9 is a flowchart for the operation of the mobile device software.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Performing document processing operations directly from a mobile device enables users to avoid the hassle of moving documents from the mobile device to a computer suitably adapted to provide document processing requests to an MFP. In many situations, a user may receive a document at his or her mobile device via email. The user may then wish to print or to fax or store that document in a network or cloud location.

That user may only be a visitor in a corporate environment or may have a new mobile device or may be presently standing in a location far from his or her usual working area. In such a case, an MFP immediately available to that user may not be configured to perform document processing operations initiated by the user's mobile device. Providing a direct network or IP address to the user for mobile device configuration may be insecure. Even with such information, configuration of a document processing operation may be beyond the scope of skills available to a user. Enabling ease of configuration of a mobile device for use with an MFP is advantageous. The retention of security while enabling such a configuration is also advantageous.

### Description of Apparatus

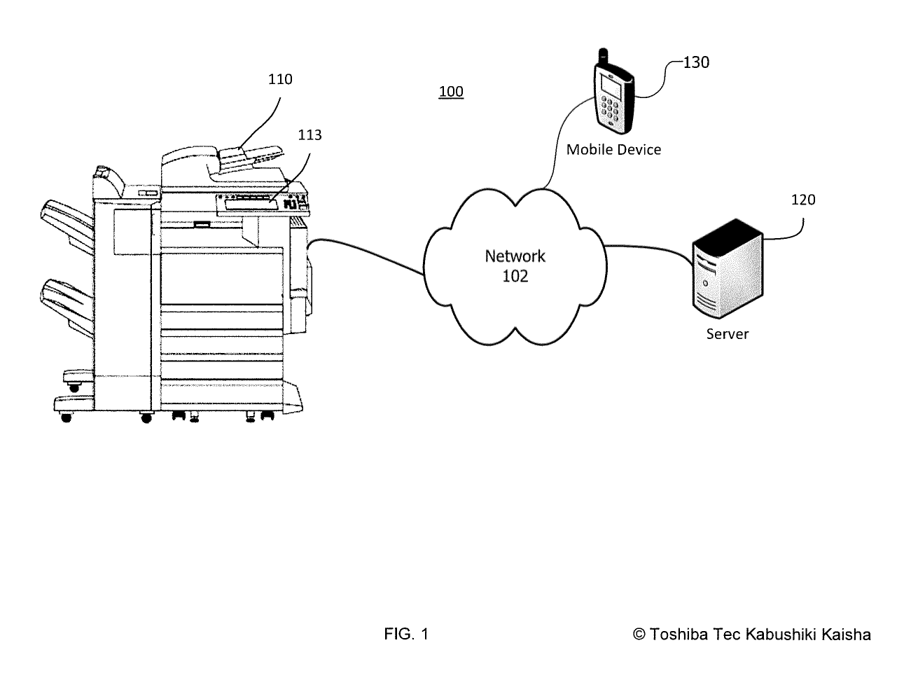

Referring now to FIG. 1 there is shown an MFP system 100. The system 100 includes an MFP 110, a server 120, and a mobile device 130, all interconnected by a network 102. The system 100 may be implemented in a distributed computing environment and interconnected by the network 102.

The network 102 may be a local area network, a wide area network, a personal area network, a mobile or telephone network, the Internet, an intranet, or any combination of these. The network 102 may have physical layers and transport layers according to IEEE 802.11, Ethernet or other wireless or wire-based communication standards and protocols such as WiMax, Bluetooth, mobile telephone and data protocols, the public switched telephone network, a proprietary communications network, infrared, and optical.

The MFP 110 may be equipped to receive portable storage media such as USB drives. The MFP 110 includes a user interface 113 subsystem which communicates information to and receives selections from users. The user interface subsystem 113 has a user output device for displaying graphical elements, text data or images to a user and a use input device for receiving user inputs. The user interface subsystem 113 may include a touchscreen, LCD display, touch-panel, alpha-numeric keypad and/or an associated thin client through which a user may interact directly with the MFP 110.

The server 120 is software operating on a server computer connected to the network. The mobile device 130 may be a mobile or handheld PC, a table or smart phone, a feature phone, or other similar device. The mobile device 130 is representative of one or more end-user devices and may be considered separate from the system 100.

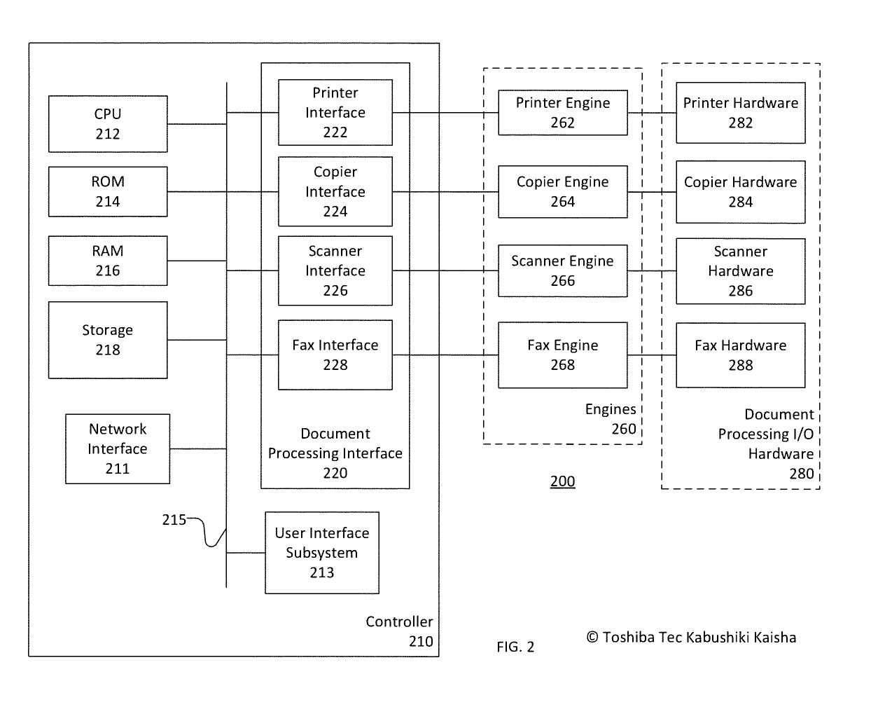

Turning now to FIG. 2 there is shown a block diagram of an MFP 200 which may be the MFP 110 (FIG. 1). The MFP 200 includes a controller 210, engines 260 and document processing I/O hardware 280. The controller 210 includes a CPU 212, a ROM 214, a RAM 216, a storage 218, a network interface 211, a bus 215, a user interface subsystem 213 and a document processing interface 220.

As shown in FIG. 2 there are corresponding components within the document processing interface 220, the engines 260 and the document processing I/O hardware 280, and the components are respectively communicative with one another. The document processing interface 220 has a printer interface 222, a copier interface 224, a scanner interface 226 and a fax interface 228. The engines 260 include a printer engine 262, a copier engine 264, a scanner engine 266 and a fax engine 268. The document processing I/O hardware 280 includes printer hardware 282, copier hardware 284, scanner hardware 286 and fax hardware 288.

The MFP 200 is configured for printing, copying, scanning and faxing. However, an MFP may be configured to provide other document processing functions, and, as per the definition, as few as two document processing functions.

The CPU 212 may be a central processor unit or multiple processors working in concert with one another. The CPU 212 carries out the operations necessary to implement the functions provided by the MFP 200. The processing of the CPU 212 may be performed by a remote processor or distributed processor or processors available to the MFP 200. For example, some or all of the functions provided by the MFP 200 may be performed by a server or thin client associated with the MFP 200, and these devices may utilize local resources (e.g., RAM), remote resources (e.g., bulk storage), and resources shared with the MFP 200.

The ROM 214 provides non-volatile storage and may be used for static or fixed data or instructions, such as BIOS functions, system functions, system configuration data, and other routines or data used for operation of the MFP 200.

The RAM 216 may be DRAM, SRAM or other addressable memory, and may be used as a storage area for data instructions associated with applications and data handling by the CPU 212.

The storage 218 provides volatile, bulk or long term storage of data associated with the MFP 200, and may be or include disk, optical, tape or solid state. The three storage components, ROM 214, RAM 216 and storage 218 may be combined or distributed in other ways, and may be implemented through SAN, NAS, cloud or other storage systems.

The network interface 211 interfaces the MFP 200 to a network, such as the network 102 (FIG. 1), allowing the MFP 200 to communicate with other devices.

The bus 215 enables data communication between devices and systems within the MFP 200. The bus 215 may conform to the PCI Express or other bus standard.

While in operation, the MFP 200 may operate substantially autonomously. However, the MFP 200 may be controlled from and provide output to the user interface subsystem 213, which may be the user interface subsystem 113 (FIG. 1).

The document processing interface 220 may be capable of handling multiple types of document processing operations and therefore may incorporate a plurality of interfaces 222, 224, 226 and 228. The printer interface 222, copier interface 224, scanner interface 226, and fax interface 228 are examples of document processing interfaces. The interfaces 222, 224, 226 and 228 may be software or firmware.

Each of the printer engine 262, copier engine 264, scanner engine 266 and fax engine 268 interact with associated printer hardware 282, copier hardware 284, scanner hardware 286 and facsimile hardware 288, respectively, in order to complete the respective document processing functions.

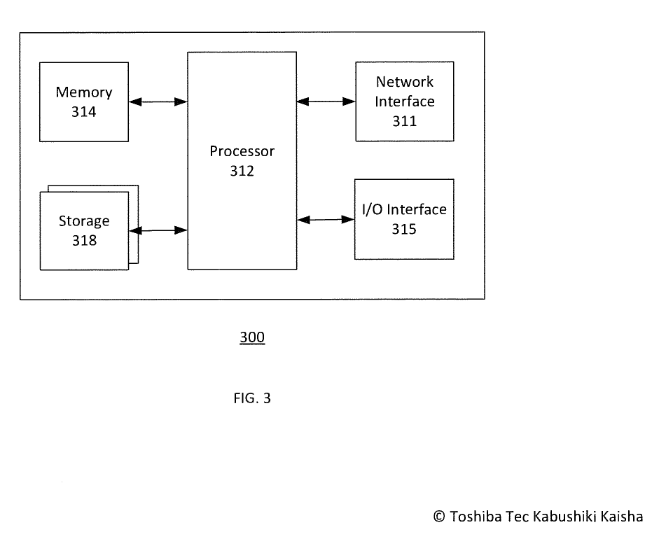

Turning now to FIG. 3 there is shown a computing device 300, which is representative of the server computers, client devices, mobile devices and other computing devices discussed herein. The controller 210 (FIG. 2) may also, in whole or in part, incorporate a general purpose computer like the computing device 300. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 has a processor 312 coupled to a memory 314, storage 318, a network interface 311 and an I/O interface 315. The processor may be or include one or more microprocessors, field programmable gate arrays (FPGAs), application specific integrated circuits (ASICs), programmable logic devices (PLDs) and programmable logic arrays (PLAs).

The memory 314 may be or include RAM, ROM, DRAM, SRAM and MRAM, and may include firmware, such as static data or fixed instructions, BIOS, system functions, configuration data, and other routines used during the operation of the computing device 300 and processor 312. The memory 314 also provides a storage area for data and instructions associated with applications and data handled by the processor 312.

The storage 318 provides non-volatile, bulk or long term storage of data or instructions in the computing device 300. The storage 318 may take the form of a disk, tape, CD, DVD, or other reasonably high capacity addressable or serial storage medium. Multiple storage devices may be provided or available to the computing device 300. Some of these storage devices may be external to the computing device 300, such as network storage or cloud-based storage.

The network interface 311 includes an interface to a network such as network 102 (FIG. 1).

The I/O interface 315 interfaces the processor 312 to peripherals (not shown) such as displays, keyboards and USB devices.

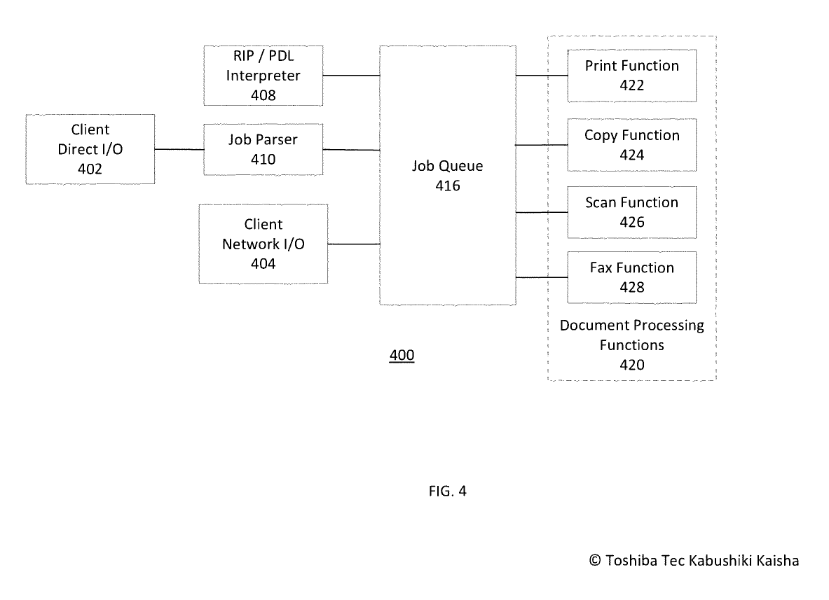

Turning now to FIG. 4 there is shown a block diagram of a software system 400 of an MFP which may operate on the controller 210. The system 400 includes client direct I/O 402, client network I/O 404, a RIP/PDL interpreter 408, a job parser 410, a job queue 416, a series of document processing functions 420 including a print function 422, a copy function 424, a scan function 426 and a fax function 428.

The client direct I/O 402 and the client network I/O 404 provide input and output to the MFP controller. The client direct I/O 402 is for the user interface on the MFP (e.g., user interface subsystem 113), and the client network I/O 404 is for user interfaces over the network. This input and output may include documents for printing or faxing or parameters for MFP functions. In addition, the input and output may include control of other operations of the MFP. The network-based access via the client network I/O 404 may be accomplished using HTTP, FTP, UDP, electronic mail TELNET or other network communication protocols.

The RIP/PDL interpreter 408 transforms PDL-encoded documents received by the MFP into raster images or other forms suitable for use in MFP functions and output by the MFP. The RIP/PDL interpreter 408 processes the document and adds the resulting output to the job queue 416 to be output by the MFP.

The job parser 410 interprets a received document and relays it to the job queue 416 for handling by the MFP. The job parser 410 may perform functions of interpreting data received so as to distinguish requests for operations from documents and operational parameters or other elements of a document processing request.

The job queue 416 stores a series of jobs for completion using the document processing functions 420. Various image forms, such as bitmap, page description language or vector format may be relayed to the job queue 416 from the scan function 426 for handling. The job queue 416 is a temporary repository for all document processing operations requested by a user, whether those operations are received via the job parser 410, the client direct I/O 402 or the client network I/O 404. The job queue 416 and associated software is responsible for determining the order in which print, copy, scan and facsimile functions are carried out. These may be executed in the order in which they are received, or may be influenced by the user, instructions received along with the various jobs or in other ways so as to be executed in different orders or in sequential or simultaneous steps. Information such as job control, status data, or electronic document data may be exchanged between the job queue 416 and users or external reporting systems.

The job queue 416 may also communicate with the job parser 410 in order to receive PDL files from the client direct I/O 402. The client direct I/O 402 may include printing, fax transmission or other input of a document for handling by the system 400.

The print function 422 enables the MFP to print documents and implements each of the various functions related to that process. These include stapling, collating, hole punching, and similar functions. The copy function 424 enables the MFP to perform copy operations and all related functions such as multiple copies, collating, 2 to 1 page copying or 1 to 2 page copying and similar functions. Similarly, the scan function 426 enables the MFP to scan and to perform all related functions such as shrinking scanned documents, storing the documents on a network or emailing those documents to an email address. The fax function 428 enables the MFP to perform facsimile operations and all related functions such as multiple number fax or auto-redial or network-enabled facsimile.

Some or all of the document processing functions 420 may be implemented on a client computer, such as a personal computer or thin client. The user interface for some or all document processing functions may be provided locally by the MFP's user interface subsystem though the document processing function is executed by a computing device separate from but associated with the MFP.

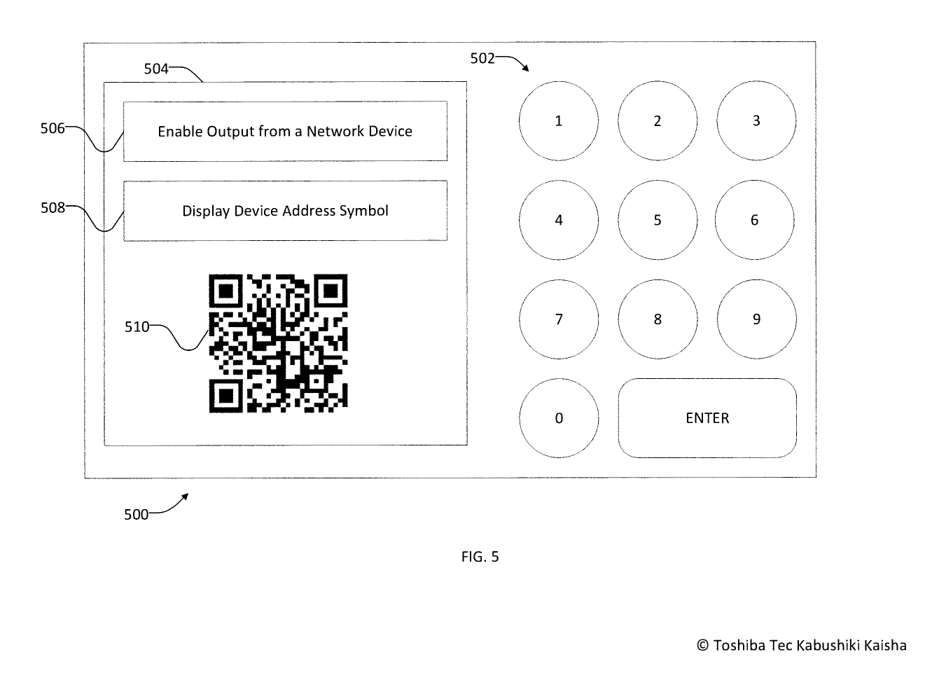

Turning now to FIG. 5 a multifunction peripheral user interface 500 is shown. The user interface 500 includes a keypad 502 and a display 504 which may include a touchscreen. The user interface 500, which may be user interface subsystem 213 of FIG. 2, is only exemplary. The user interface may include only a display or a combination (as shown) of a display and hardware buttons in the form of a keypad 502.

The user interface 500 shows on the display 504 a sample screen in which two buttons 506, 508 and a machine-readable symbol 510 are visible. The first button 506 is used to enable output from a network device. This button 506 causes the MFP to be capable of outputting documents sent to it via the network. In some cases, this button may not be present. However, including this button enables higher security by ensuring that a user standing in front of the MFP is the same (or in close communication with) the user transmitting a document processing request. The controller of the MFP may disable printing via a network request, or via a request sent to an address, and/or with authentication associated with the machine-readable symbol 510 after a predetermined time, such as five minutes, after the machine-readable symbol 510 is displayed or after the first button 506 is used to enable output from a network device.

The second button 508 is used to enable display the device address symbol. In some cases, the functionality of the first button 506 and the second button 508 may be combined such that requesting display may enable output from a network device for a predetermined (or indefinite) period of time. The second button 508 causes the machine-readable symbol 510 such as a QR code or other, machine-readable symbol to be displayed. In some cases, discussed more fully below, the second button 508 or similar functionality may cause the controller of the MFP to access a cached machine-readable symbol or to generate a new machine-readable symbol.

The machine-readable symbol 510 may be an encoded form of (or refer in a readily-accessible database to) a URL, an IP address, a username, a password, a checksum, an authentication credential and any combination of these. The machine-readable symbol 510 is shown as a QR code by way of an example, but a barcode, a serial number, or other machine-readable symbol may be used. The machine-readable symbol 510 or other machine-readable symbol is presented with sufficient size, clarity and contrast to enable it to be scanned and parsed by a camera included in a mobile device.

The machine-readable symbol 510 may be a reference, such as a Uniform Resource Locator (URL) to a software application suitable for scanning, parsing and enabling a mobile device to make document processing requests of an MFP. Once the user has obtained a suitable software application, the machine-readable symbol 510 may be refreshed to then disclose a network address or other data.

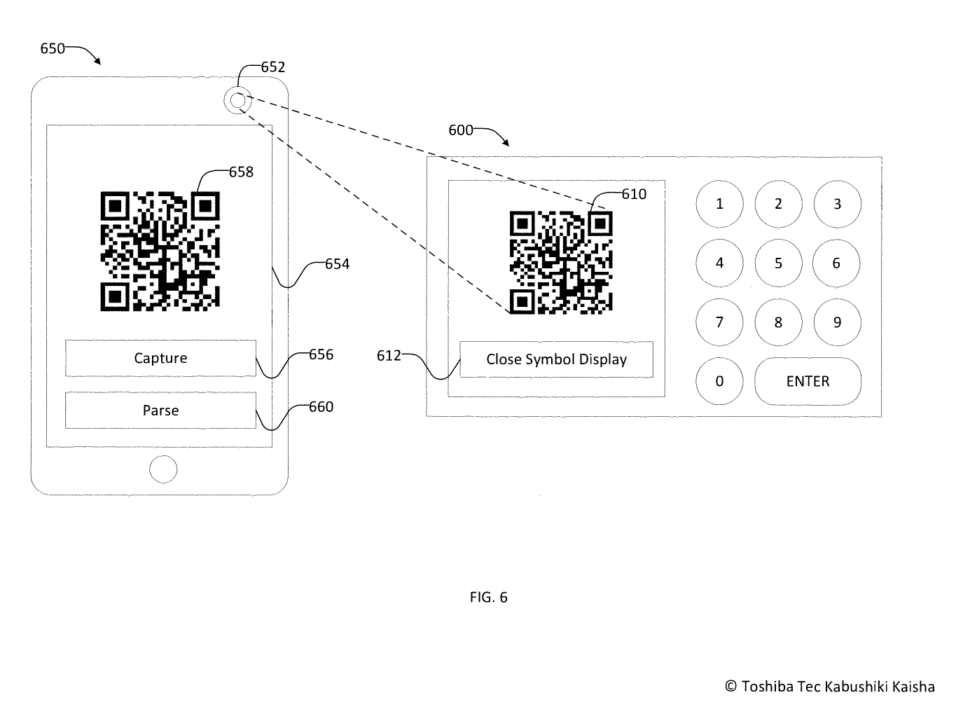

Referring now to FIG. 6, a multifunction peripheral user interface 600 and a mobile device 650 including a camera 652 and a mobile device user interface 654. The machine-readable symbol 610 is visible along with a close symbol display button 612. The close symbol display 612 is an optional button that will end the display of the machine-readable symbol 610 so that other actions may be taken using the MFP user interface 600.

The mobile device 650 includes the user interface which may be or include a display which may be or include a touchscreen. A user of the mobile device 650 may use the included camera 652 to capture the displayed machine-readable symbol 610. Once captured, the machine-readable symbol 658 may be displayed on the user interface 654.

The user may use the capture button 656 on the user interface 654 to capture the machine-readable symbol 658 with the camera 652. Software on the mobile device 650 may then automatically, or through user interaction with the parse button 660, parse the machine-readable symbol 658 to thereby obtain a network address and any other information encoded into the machine-readable symbol 658.

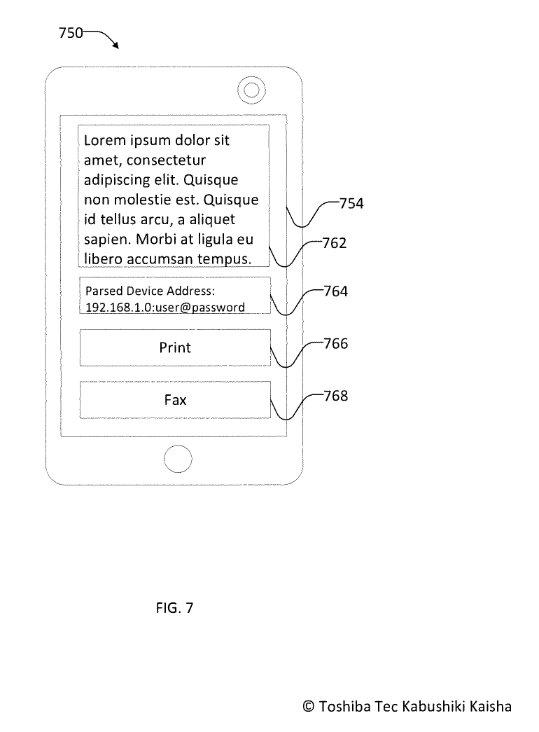

FIG. 7 shows a mobile device 700 including a mobile device user interface 754. The user interface 754 includes a text portion 762 that may be obtained, for example, from a document resident on the mobile device 750, or accessible to the mobile device 750 through software, such as email software, or through cloud-based storage access software or word-processing, spreadsheet or similar software. Alternatively, the mobile device 750 may include software specifically designed for capturing machine-readable symbols and then accessing documents to be output using the data derived from those machine-readable symbols.

The user interface 754 of FIG. 7 is exemplary of such software. Once the user has selected a document or date to be output via the data derived from the machine-readable symbol, that data may be shown to the user. If it is text, for example, that text may be shown in the text portion 762. If it is a spreadsheet, a portion or all of that spreadsheet may be shown to the user in a similar area of the user interface 754.

Simultaneously, or in a separate portion of the user interface 754, the parsed device address may be shown to the user in an address information box 764. In some cases, this information may be unavailable to a user, for example, for security purposes. The device may remain capable of transmitting a print job, but not provide direct access, for example, to an IP address or to any associated authentication credentials provided to the user.

Here, the address information box 764 shows that the parsed machine-readable symbol 658 has resulted in data of “192.168.1.0:user@password”. This is merely exemplary of one potential type of data that may be encoded in a machine-readable symbol, such as machine-readable symbol 658. In this case, the first portion of this data is a network address in the form of an IP address suitable for sending document processing requests to the MFP that provided the machine-readable symbol 658. In addition, a username of “user” and a password of “password” are also provided as authentication credentials for the mobile device.

These authentication credentials may be required to be included along with any document processing request. Without the authentication credentials, any document processing request to an MFP sent to the network address may be denied. The authentication credentials may be particular to the MFP and may be assigned by an administrator. In some cases, these credentials may not be made directly available to the user of the mobile device 750 for security purposes.

Authentication credentials may automatically or periodically change. The authentication credentials and/or the network address provided in the machine-readable symbol 658 may change, for example, after each use or after every X uses where X is greater than one based upon administrator settings. Alternatively, the machine-readable symbol may change when configuration changes or updates are made to an MFP, for example, by an administrator. In such cases, the machine-readable symbol must be updated to incorporate the new data.

The user interface 754 shows two function buttons, a print button 766 and a fax button 768. These represent MFP functions, discussed more fully above. The print button 766 causes the mobile device 750 to communicate a document processing request to the MFP (optionally using the authentication credentials) instructing the MFP to print the document attached to or referred to in (for example a document stored on a network drive or in the cloud) the document processing request.

The fax button 768 causes the mobile device to communicate a document processing request to the MFP (optionally using the authentication credentials) instructing the MFP to fax the document attached to or referred to in the document processing request to an identified facsimile number. Still other document processing requests, such as an instruction to email a document to an email address, store on a network drive or a cloud service (and including authentication suitable for accessing that cloud service or network drive), a request to print a document at an identified remote MFP (such as another MFP at another location or an MFP identified by another network address) and other document processing requests may also be made and may also have associated buttons on the user interface 754.

### Description of Processes

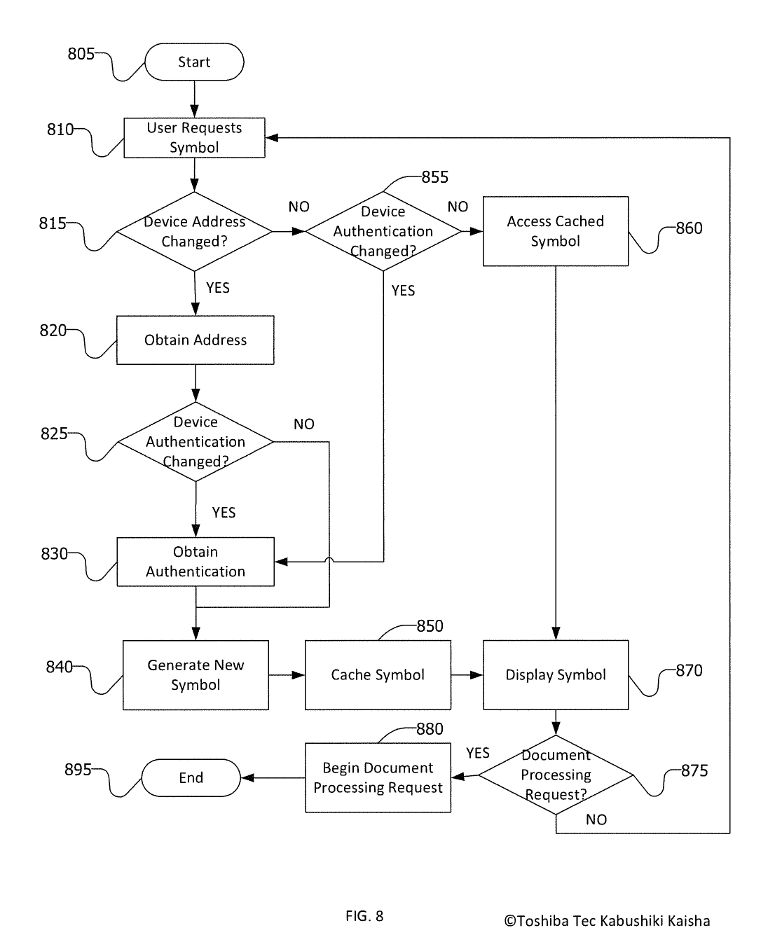

Turning now to FIG. 8, a flowchart for the operation of the multifunction peripheral is shown. FIG. 8 has a start 805 and an end 895, but may be iterative. Many instances of the process shown in FIG. 8 may be taking place simultaneously or in parallel.

First, a user of the MFP requests a machine-readable symbol at 810. This request instructs the MFP to display such a symbol on the MFP user interface, such as user interface 500. The MFP controller then determines if the device address has changed at 815. This determination may also include a determination that the present network address has been active for more than a predetermined period of time and that a new address is required.

If the MFP address has changed, then the MFP controller obtains the new address 820. This process may involve resolution of a new network name, URL, IP address or similar address in a different addressing scheme. Alternatively, this process may involve merely refreshing the network address.

Once the new address is obtained at 820, the controller determines whether the device authentication credentials have changed at 825. As discussed briefly above, the MFP controller may be programmed in such a way that authentication is automatically- or administrator-generated. The authentication credentials may be set to change periodically, after each use or after a series of uses to process remote document processing requests. Alternatively, the device authentication credentials may remain the same until changed. If the authentication has changed, new authentication credentials are obtained at 830.

If the authentication credentials have not changed at 825 or once the authentication is updated at 830, a new machine-readable symbol is generated at 840. The new symbol is necessary when either the network address or the authentication credentials have changed if the machine-readable symbol actually encodes the data. In implementations where the machine-readable symbol is merely a reference to the network address and the authentication credentials (for example, a URL to a database containing the data), the machine-readable symbol may not change when either the network address or authentication credentials change.

Once the new symbol is generated at 840, the symbol is cached at 850 for later use. In situations in which the device address has not changed at 815 and in which the device authentication has not changed at 855, the cached symbol may be accessed at 860 in order to display that symbol to the user on the user interface at 870. The display may appear in a manner similar to that shown in FIG. 5.

If a document processing request, using the network address and the device credentials is received at 875, the document processing request, such as printing, faxing, emailing, storing in a cloud service, or other request is begun at 880. If a document processing request is not received, the availability of the network address and authentication credentials may time out and begins again with a user request at 810.

In some situations, such as when set by a user administrator, new authentication credentials may be required for the next request. This may aid in security by ensuring that a user cannot utilize the functionality of an MFP from a remote location days or weeks after obtaining a network address and authentication credentials via a user interface as described herein. If the authentication credentials periodically change or are single-use and the process times out after a predetermined period of time, especially if the parsed contents of the machine-readable symbol are not made visible to a user, then the user must have recently had access to the MFP before he or she can submit document processing requests to the MFP.

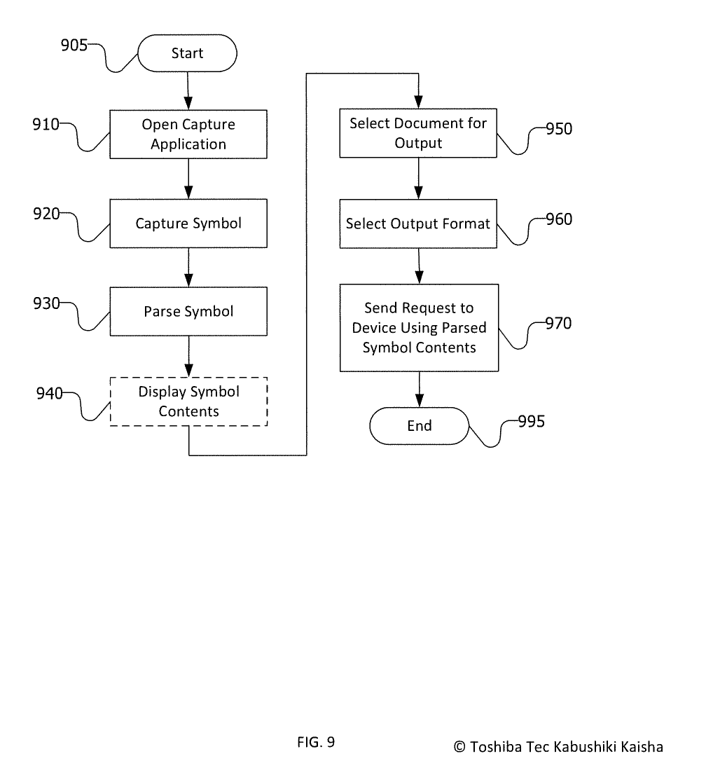

FIG. 9 shows a flowchart for the operation of the mobile device software. FIG. 9 has a start 905 and an end 995, but may be iterative. Many instances of the process shown in FIG. 9 may be taking place simultaneously or in parallel.

A user opens the capture application on the mobile device at 910. The capture application may be an application designed specifically for use with MFPs or a particular brand of MFPs. The application may incorporate the capability to also open files stored or otherwise available (via a network or cloud storage) to a mobile device. Alternatively, the capture application may be an application designed to scan machine-readable symbols, such as QR codes, and to deliver to a user or the application or another application, relevant data such as the network address and authentication credentials included in a machine-readable symbol.

The capture application on the mobile device may be used, then, to capture the symbol 920. An example of this process may be seen, for example, in FIG. 6. This may occur using the camera, such as camera 652, of the mobile device and may be triggered by interaction with a user interface element, such as the capture button 656.

The capture application on the mobile device may then be used to parse the machine-readable symbol at 930. This process may be triggered by user interaction with the mobile device user interface. This may be, for example, user selection of the parse button 660. The process of parsing the machine-readable symbol may involve translation of the data represented by the symbol, for example in the form of a QR code, into the data that the symbol represents. As shown above, a particular QR code may be translated into an IP address and authentication credential combination. Alternatively, the parsing of the symbol may involve accessing a URL referenced by the machine-readable symbol to thereby obtain a network address and/or authentication credentials. A hybrid process including both data and a data location where, for example, authentication credentials may be obtained, may also be used.

Next, the contents of the parsed machine-readable symbol may be displayed to the user on the capture application at 940. This step is shown as optional because it may be disabled by an administrator seeking to add security to the machine-readable device discovery process. The administrator may wish to shield direct access to the contents of the machine-readable symbol data from users. The machine-readable symbol may also be encoded in such a way that other machine-readable symbol readers, apart from ones designed specifically to work with MFPs or a brand of MFPs may be unable to parse the contents after capturing them. In this way, a level of security may be added to the process. In other cases, the capture application may provide the data from the symbol in a form suitable for use by a user of the mobile device.

Next, the user may select a document for output via the MFP at 950. This process may take place within the capture application or may involve the use of other applications such as email applications, web browsers, cloud storage accessing applications and other, similar, applications which may be used to access documents for which document processing requests may be generated for output via the MFP. The capture application may integrate in whole or in part with network drives, other applications, cloud storage services and similar other applications and services to access documents directly. Alternatively, the capture application may integrate such that it is able to share the parsed data with other applications thus enabling those applications to access the MFP in order to generate document processing requests.

Next, the user may select the output format for the document processing request at 960. The output format may be print and may include details about the print job such as the number of copies, double-sided printing, type, font, color or black and white printing, delayed printing, secure printing and various, other print settings. The output format may be facsimile and may include input of a facsimile number. In some cases, the facsimile number may be obtained from the user's contacts on the mobile device.

The output format may be to store a document or a form of the document on a shared network location or in a cloud service. In such cases, the selection of the output format may also involve input of or access to previously-stored authentication credentials for the network location or cloud service. In other cases, the output format itself, when the document processing request is generated via the process described herein, using a network location and authentication credentials granting access to use the MFP, may grant access to one or more network locations or cloud services. For example, once a proper document processing request is made, the MFP's own credentials may be used to access the shared network location or a cloud storage service.

Finally, the document processing request, including the document and any associated settings, may be sent to the MFP using the parsed symbol contents, such as the network address and the authentication credentials at 970. Such a request, validly received, will be processed as described in FIG. 8.

### Closing Comments

Throughout this description the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for multifunction peripheral discovery through a user interface comprising:
obtaining a uniquely identifying network address for the multifunction peripheral, the uniquely identifying network address received from a network address source;
generating a machine-readable symbol embodying the uniquely identifying network address and associated authentication credentials;
determining that a user has initiated a display request for the display of the machine-readable symbol on the user interface of the multifunction peripheral;
displaying the machine-readable symbol on a display associated with the user interface of the multifunction peripheral;
accepting a document processing request sent via a network to the uniquely identifying network address associated with the machine-readable symbol, the document processing request including the authentication credentials; and
beginning the document processing request using the multifunction peripheral.

2. The method of claim 1 wherein the machine-readable symbol is a selected one of a QR code and a barcode.

3. The method of claim 1 further comprising:
determining that the network address has been updated to a new network address; and
generating a new machine-readable symbol embodying the new network address and the authentication credentials.

4. The method of claim 1 further comprising:
determining that the authentication credentials have expired;
generating new authentication credentials; and
generating a new machine-readable symbol embodying the network address and associated with the new authentication credentials.

5. The method of claim 1:
wherein the display is integral to the multifunction peripheral; and
further wherein, upon receipt of the document processing request, the multifunction peripheral is capable of independently completing the document processing request.

6. The method of claim 1 implemented in a processor and associated memory in the multifunction peripheral.

7. An apparatus, including a processor and associated memory, the apparatus including software that when executed by the processor causes the processor to:
obtain a uniquely identifying network address for the multifunction peripheral, the uniquely identifying network address received from a network address source;
generate a machine-readable symbol embodying the uniquely identifying network address and associated authentication credentials;
determine that a user has initiated a display request for the display of the machine-readable symbol on a user interface of the multifunction peripheral;
display the machine-readable symbol on a display associated with the user interface of the multifunction peripheral;
accept a document processing request sent via a network to the uniquely identifying network address associated with the machine-readable symbol, the document processing request including the authentication credentials; and
begin the document processing request using the multifunction peripheral.

8. The apparatus of claim 7 wherein the machine-readable symbol is a selected one of a QR code and a barcode.

9. The apparatus of claim 7 wherein the software when executed by the processor further causes the processor to:
determine that the network address has been updated to a new network address; and
generate a new machine-readable symbol embodying the new network address and the authentication credentials.

10. The apparatus of claim 7 wherein the software when executed by the processor further causes the processor to:
determine that the authentication credentials have expired;
generate a new authentication credentials; and
generate a new machine-readable symbol embodying the network address and associated with the new authentication credentials.

11. The apparatus of claim 7:
wherein the display is integral to the multifunction peripheral; and
further wherein, upon receipt of the document processing request, the multifunction peripheral is capable of independently completing the document processing request.

12. The apparatus of claim 7 wherein the processor and associated memory are incorporated in a multifunction peripheral.

13. Apparatus comprising a multifunction peripheral for enabling device discovery through a user interface:
a controller for generating a machine-readable symbol embodying the uniquely identifying network address and authentication credentials, the controller further for determining that a user has initiated a display request for the display of the machine-readable symbol on a user interface of the multifunction peripheral;
a user interface of the multifunction peripheral for displaying the machine-readable symbol on a display associated with the user interface;
a network interface for accepting a document processing request sent via a network to the uniquely identifying network address associated with a machine-readable symbol, the document processing request including the authentication credentials; and
a document processing interface for beginning the document processing request using the multifunction peripheral.

14. The multifunction peripheral of claim 13 wherein the user initiates the display request by making a selection using the user interface.

15. The multifunction peripheral of claim 13 wherein the machine-readable symbol is a selected one of a QR code and a barcode.

16. The multifunction peripheral of claim 13 wherein the controller is further for:
determining that the network address has been updated to a new network address; and
generating a new machine-readable symbol embodying the new network address and the authentication credentials.

17. The apparatus of claim 7 wherein the controller is further for:
determining that the authentication credentials have expired;
generating new authentication credentials; and
generating a new machine-readable symbol embodying the network address and associated with the new authentication credentials.

18. The multifunction peripheral of claim 15:
wherein the display is integral to the multifunction peripheral; and
further wherein, upon receipt of the document processing request, the multifunction peripheral is capable of independently completing the document processing request.
